(19) United States
(12) Patent Application Publication
(10) Pub. No.: US 2026/0366163 A1
(43) Pub. Date: Nov. 19, 2026

(54) METHOD FOR PRODUCING A MOLD INSERT FOR AN INJECTION MOLD, AND MOLD INSERT

(71) Applicant: HELLA GmbH & Co. KGaA, Lippstadt (DE)

(72) Inventor: Dietmar HAUT, Lippstadt (DE)

(73) Assignee: HELLA GmbH & Co. KGaA, Lippstadt (DE)

(21) Appl. No.: 19/681,161

(22) Filed: May 19, 2026

(30) Foreign Application Priority Data
May 19, 2025 (DE) 10 2025 119 300.2

(51) Int. Cl. C23C 18/18; B29C 45/37; C23C 18/16; C23C 18/32; B29L 11/00

(52) U.S. Cl. CPC C23C 18/1806; B29C 45/372; C23C 18/1689; C23C 18/32; B29K 2905/00; B29K 2995/0072; B29L 2011/00

(57) ABSTRACT

A method for producing a mold insert for an injection mold, in particular for injection molding optical components of motor vehicle lighting devices. A body of the mold insert is provided, in particular made of a tool steel. The body is machined to create a preliminary mold surface. The preliminary mold surface is coated via electroless nickel plating, and the electroless nickel layer is machined to create the final mold surface.

This nonprovisional application claims priority under 35 U.S.C. § 119(a) to German Patent Application No. 10 2025 119 300.2, which was filed in Germany on May 19, 2025, and which is herein incorporated by reference.

### BACKGROUND OF THE INVENTION

### Field of the Invention

The present invention relates to a method for producing a mold insert for an injection mold, in particular for injection molding optical components of motor vehicle lighting devices.

### Description of the Background Art

Optical components of motor vehicle lighting devices, for example various lens types, reflectors, light guiding elements, and cover lenses, generally are produced with the injection molding process. A crucial parameter for the functionality of such optical components is their surface finish. Smooth surfaces are necessary for high-efficiency singlet lenses or reflectors, for instance, whereas well defined surface textures are to be formed for light-diffusing elements or microlens arrays. The surface finish of the molded optical components is directly determined by the surface quality of the applicable mold, which therefore must meet high quality requirements.

Injection molds customarily are equipped with mold inserts that constitute the contact surface for the injected molding compound, and have the negative of the desired surface topography of the optical components. To meet the requirements for the surface quality of the mold inserts as well as their wear resistance and service life in mass production, many approaches are known in the prior art that are based, in particular, on an appropriate choice of material, functional coatings, and different methods of surface treatment.

### SUMMARY OF THE INVENTION

It is therefore an object of the present invention to provide a method for producing a mold insert for an injection mold that, in particular, is suitable for injection molding optical components having especially high requirements for the surface finish.

In an example, provided is a method that comprises: providing a body of the mold insert, in particular made of a tool steel; machining the body to create a preliminary mold surface; coating the preliminary mold surface by means of electroless nickel plating; and machining the electroless nickel layer to create the final mold surface.

The invention is based on the finding that machining of electroless nickel layers produces a surprisingly excellent surface quality so that, in combination with the high hardness, corrosion resistance, and dimensional stability of electroless nickel layers, a mold insert with an extremely high-performance mold surface is created.

Electroless nickel plating, also referred to as electroless nickel deposition, is an autocatalytic coating process in which the reduction of nickel ions in a solution and the deposition of a nickel layer by the oxidation of a reducing agent present in the solution itself take place. In contrast to electroplating, it is not necessary for electric current to flow through the solution for layer deposition. Electroless nickel plating produces an especially conformal coating with a homogeneous layer thickness, and can be applied even to nonconductive surfaces when suitable catalysts are employed. Electroless nickel layers have a very dense structure and are therefore suitable as corrosion protection for the body of the mold insert in the present case. During the coating of the preliminary mold surface, preferably the electroless nickel layer is deposited with a phosphorus content in the range from 10 percent by weight to 15 percent by weight, in particular 11 percent by weight to 13 percent by weight, resulting in a high layer hardness as additional wear protection.

According to an example of the invention, the electroless nickel layer is deposited on the preliminary mold surface of the mold insert body. The latter is prepared from a tool steel that is suitable for applications in injection molds, for example. The creation of the preliminary mold surface is carried out by machining the body, in particular by means of milling. For example, the creation of the preliminary mold surface is carried out to the level of a fine finishing operation and produces a surface corresponding to a roughness class in the range from N4 to N5 according to DIN EN ISO 1302.

Preferably, the preliminary mold surface on the body is produced with an undersize in the range from 10 micrometers to 50 micrometers, in particular 25 micrometers to 35 micrometers, in comparison with the final mold surface of the mold insert. During the subsequent coating of the preliminary mold surface, an electroless nickel layer is then deposited with a layer thickness in the range from preferably 30 micrometers to 100 micrometers, in particular 60 micrometers to 80 micrometers. For deposition of an electroless nickel layer in these layer thickness ranges, a process duration of only some hours is necessary, which is a substantially faster deposition rate than in electrolytic nickel plating.

The subsequent machining of the electroless nickel layer to create the final mold surface preferably is carried out by means of milling with a diamond tool. In this case, a surface can be produced corresponding to a roughness class in the range from N0 to N1 (according to DIN EN ISO 1302), which fulfills the highest requirements for the surface finish of injection molded optical components.

The invention also relates to a mold insert that is produced by means of the method according to the invention in accordance with one of the above embodiments, and that is designed for an injection mold for injection molding of singlet lenses, Fresnel lenses, microlens arrays, reflectors, diffusers, antireflection structures, optical fibers, light guiding elements, thick-wall optics, or cover lenses for motor vehicle lighting devices. To this end, the final mold surface of the mold insert preferably corresponds to roughness class N0 or N1 (according to DIN EN ISO 1302).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the body with the preliminary mold surface,

FIG. 2 shows the body after nickel plating,

FIG. 3 shows the machining of the electroless nickel layer, and

FIG. 4 shows a mold insert according to the invention.

### DETAILED DESCRIPTION

The figures each show schematic, sectional views of a detail of the mold insert 1 according to the invention or of intermediate steps in the manufacture thereof. The mold insert 1 is designed for an injection mold for injection molding of a Fresnel lens by way of example.

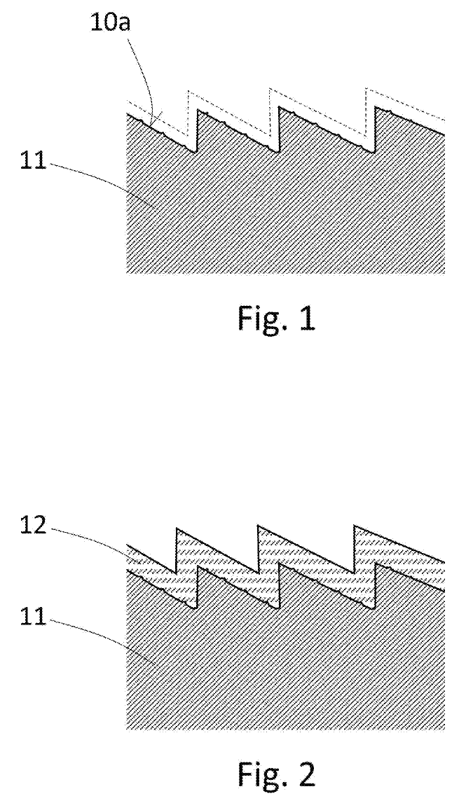

FIG. 1 shows the body 11 made of a tool steel after the machining process that created the preliminary mold surface 10a. The latter is characterized by a surface texture with a sawtooth cross section. The manufacturing-related roughness superimposed on this surface texture corresponds approximately to a roughness class in the range from N4 to N5. The dashed line corresponds to the desired shape of the final mold surface 10, wherein the undersize of the preliminary mold surface 10a is 30 micrometers, for example.

FIG. 2 shows the condition after the coating of the preliminary mold surface 10a of the body 11 by means of electroless nickel plating. The electroless nickel layer 12 deposited in this process has a conformal shape and a layer thickness of, e.g., 70 micrometers.

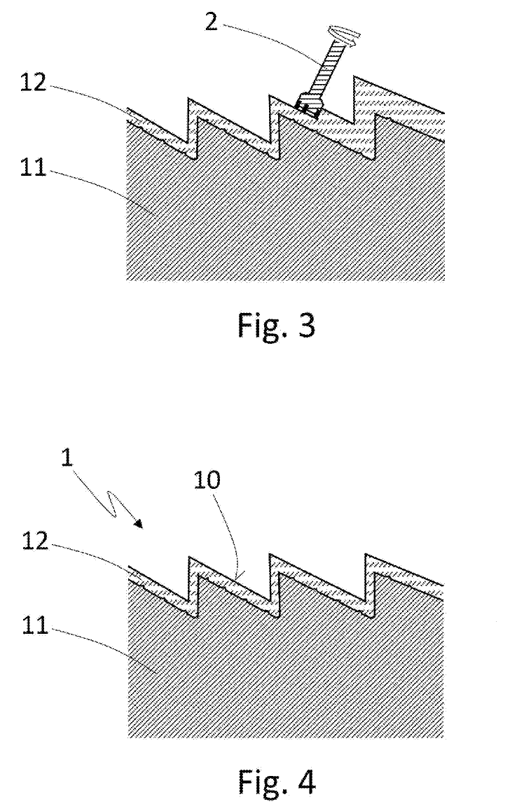

FIG. 3 shows the machining of the electroless nickel layer 12 by means of milling with the diamond tool 2. In this process, the final mold surface 10 of the mold insert 1 depicted in FIG. 4 is created. The surface quality on the electroless nickel layer 12 that can be achieved by means of the diamond tool 2 corresponds to a roughness class in the range from N0 to N1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a mold insert for an injection mold for injection molding optical components of motor vehicle lighting devices, the method comprising:
providing a body of the mold insert made of a tool steel;
machining the body to create a preliminary mold surface;
coating the preliminary mold surface via electroless nickel plating; and
machining the electroless nickel layer to create the final mold surface.

2. The method according to claim 1, wherein the machining of the electroless nickel layer is carried out via milling with a diamond tool.

3. The method according to claim 1, wherein the preliminary mold surface is produced with an undersize in the range from 10 micrometers to 50 micrometers or 25 micrometers to 35 micrometers, in comparison with the final mold surface.

4. The method according to claim 1, wherein the electroless nickel layer is deposited with a layer thickness in the range from 30 micrometers to 100 micrometers or 60 micrometers to 80 micrometers during the coating of the preliminary mold surface.

5. The method according to claim 1, wherein the electroless nickel layer is deposited with a phosphorus content in the range from 10 percent by weight to 15 percent by weight, or 11 percent by weight to 13 percent by weight, during the coating of the preliminary mold surface.

6. A mold insert for an injection mold for injection molding optical components of motor vehicle lighting devices, wherein the mold insert is produced by the method according to claim 1.

7. The mold insert according to claim 6, wherein the final mold surface corresponds to a roughness class N0 or N1 according to DIN EN ISO 1302.

8. The mold insert according to claim 6, wherein the mold insert is designed for an injection mold for injection molding of singlet lenses, Fresnel lenses, microlens arrays, reflectors, diffusers, antireflection structures, optical fibers, light guiding elements, thick-wall optics, or cover lenses for motor vehicle lighting devices.
